(19) United States
(12) Patent Application Publication
(10) Pub. No.: US 2025/0301045 A1
(43) Pub. Date: Sep. 25, 2025

(54) CLOUD IOT COMPUTING SYSTEM

(71) Applicant: Duplicent, LLC, Santa Monica, CA (US)

(72) Inventor: Curren Emmett Krasnoff, Santa Monica, CA (US)

(21) Appl. No.: 18/936,216

(22) Filed: Nov. 4, 2024

Related U.S. Application Data
(63) Continuation of application No. 18/615,597, filed on Mar. 25, 2024, now abandoned.
Application No. 18/615,597 is a continuation of application No. PCT/US2021/061225, filed on Nov. 30, 2021.
(60) Provisional application No. 63/248,494, filed on Sep. 26, 2021.

(51) Int. Cl. H04L 67/00; H04L 67/12

(52) U.S. Cl. CPC H04L 67/34; H04L 67/12

(57) ABSTRACT

One embodiment relates to a cloud computing system. The cloud computing system includes one or system devices configured to collect and transmit data. The cloud computing system also includes an internet-of-things (IoT) cloud configured to provide processing and memory storage capabilities to the system devices. The IoT cloud includes one or more device software applications configured to run the one or more system devices and a processing circuit comprising at least one processor and memory, the memory having instructions stored thereon, that when executed by the at least one processor cause the processing circuit to: communicably couple the one or more system devices to the IoT cloud through a network, receive data from the one or more system devices, determine a correct software application of the one or more device software applications to stream to a correct device of the one or more system devices based on the data received from the one or more system devices, and stream the correct software application to the correct device. The software applications are not stored locally on the one or more system devices in the cloud computing system.

### CROSS-REFERENCE TO RELATED PATENT APPLICATIONS

The present Application is a continuation of U.S. patent application Ser. No. 18/615,597, filed on Mar. 25, 2024, which is a continuation of International Application No. PCT/US2021/061225, filed on Nov. 30, 2021, which claims the benefit of and priority to U.S. Provisional Application No. 63/248,494, filed on Sep. 26, 2021, the entire disclosure of which is incorporated by reference herein.

### BACKGROUND

Current internet of things computing systems require processing capabilities on devices associated with the internet of things computing systems. For example, each device in the computing system may include memory devices (e.g., storage, databases, etc.) and processing devices (e.g., CPUs, etc.). Having processing and memory devices on each de-vice within the computing system which takes up extra space leading to larger and more ex-pensive devices.

### SUMMARY

One embodiment relates to a cloud computing system. The cloud computing system includes one or system devices configured to collect and transmit data. The cloud computing system also includes an internet-of-things (IoT) cloud configured to provide processing and memory storage capabilities to the system devices. The IoT cloud includes one or more device software applications configured to run the one or more system devices and a processing circuit comprising at least one processor and memory, the memory having instructions stored thereon, that when executed by the at least one processor cause the processing circuit to: communicably couple the one or more system devices to the IoT cloud through a network, receive data from the one or more system devices, determine a correct software application of the one or more device software applications to stream to a correct device of the one or more system devices based on the data received from the one or more system devices, and stream the correct software application to the correct device. The soft-ware applications are not stored locally on the one or more system devices in the cloud computing system.

One embodiment relates to a cloud computing system. The cloud computing sys-tern includes one or system devices configured to collect and transmit data. The cloud computing system also includes an internet-of-things (IoT) cloud configured to provide processing and memory storage capabilities to the system devices. The IoT cloud includes one or more device software applications configured to run the one or more system devices and a processing circuit comprising at least one processor and memory, the memory having instructions stored thereon, that when executed by the at least one processor cause the processing circuit to: receive a geolocation for each of the one or more system devices, com-pare the geolocation for each of the one or more system devices, determine a location where one or more system devices have the same location based on the comparison, designate one of the one or more system devices at the location as a management device for all the system devices associated with the location, communicably couple the management device to the IoT cloud through a network, receive data from the management device, determine a correct software application of the one or more device software applications to stream to a correct device of the one or more system devices based on the data received from the management device, and stream the correct software application to the correct device. The software ap-plications are not stored locally on the one or more system devices in the cloud computing system.

One embodiment relates to a cloud computing system. The cloud computing sys-tern includes one or system devices configured to collect and transmit data. The cloud computing system also includes an internet-of-things (IoT) cloud configured to provide processing and memory storage capabilities to the system devices. The IoT cloud includes one or more device software applications configured to run the one or more system devices and a processing circuit comprising at least one processor and memory, the memory having instructions stored thereon, that when executed by the at least one processor cause the processing circuit to: receive a geolocation for each of the one or more system devices, com-pare the geolocation for each of the one or more system devices, determine a where one or more system devices have the same location based on the comparison, generate an edge cloud to be located near the location where the one or more system devices have same location based on the comparison, and communicably couple the one or more system devices to the edge cloud through a network. The software applications are not stored locally on the one or more system devices in the cloud computing system.

### BRIEF DESCRIPTION OF THE DRAWINGS

The details of one or more implementations are set forth in the accompanying drawings and description below. Other features, aspects, and advantages of the disclosure will become apparent from the description, the drawings, and the claims, in which:

FIG. 1 is an illustration of an example cloud computing system for management of one or more devices, according to some implementations;

FIG. 2 is another illustration of an example cloud computing system for management of one or more devices, according to some implementations;

FIG. 3 is another illustration of an example cloud computing system for management of one or more devices, according to some implementations; and

FIG. 4 is an illustration of a smart home system connected to the example could computing system of FIG. 2, according to some implementations.

FIG. 5 is an illustration of a smart agricultural system connected to the example could computing system of FIG. 3, according to some implementations.

FIG. 6 is an illustration of a smart traffic system connected to the example could computing system of FIG. 1, according to some implementations.

Like reference numbers and designations in the various drawings indicate like elements.

### DETAILED DESCRIPTION

Processing devices and memory devices may be used to facilitate an internet of things (IoT) computing system. Current computing systems require processing capabilities on devices associated with the internet of things computing systems. For example, each local device in the computing system may include memory devices (e.g., storage, databases, etc.) and processing devices (e.g., CPUs, etc.). Having processing and memory devices on each device within the computing system which takes up extra space leading to larger and more expensive devices.

For example, a user may wish to install a number of software applications on one or more system devices. Each software application may consume memory, thereby degrading the performance of the system device, and making it difficult or impossible to install future software applications on the system device. In some cases, a user may be limited by the memory and/or processing capabilities of their system device in how many applications they may install. For example, a system device may only be able to install three software applications before the memory is completely allotted. Consequently, a user may be unable to install new software applications on the system device without deleting the existing soft-ware applications. Deleting old software applications to install new applications may be irritating to the user and may reduce the utility of the system device to the user.

Furthermore, the installed applications may require installation of additional re-sources (e.g., software updates, scripts, etc.). For example, a legacy application may require additional program code to continue functioning. However, these additional resources may not be able to be installed on the system device because the three existing applications take up all the memory space available on the system devices. Additionally, general performance of the system may be negatively affected when all the memory on the system device is completely used up. For example, a system device may be unable to run legacy applications properly or the system device may overheat if not enough memory space is left on the system device.

Therefore, systems and methods for relocating the memory and processing capabilities from the local devices to an IoT cloud computing in order to preserve space on the system devices may be desired. The IoT cloud computing system with proxy memory and processing capabilities can be used to free up space for phones, tablets, laptops, watches, wearables, TVs, gaming systems etc. The systems and methods discussed herein provide for limitless memory and processing capabilities on IoT cloud which may be connected to one or more system devices allowing for flexible device software applications stored on the IoT cloud which may be used and accessed through the system devices. More specifically, de-vice software applications may be stored and processed on the IoT cloud and streamed to the system device through a device software application streaming device. The device soft-ware application streaming device may prepare and send device software applications from the IoT cloud to the system devices. A user may interact with the remotely hosted device software applications as if they were installed on the system device directly. The device software application streaming device may utilize remote desktop protocol (RDP), HDX, RemoteFX, and any other protocol to facilitate a connection between the system devices and cloud IoT. In various embodiments, the device software application streaming device can format application data received from the cloud IoT for display on different systems. For example, the device software application streaming device may format application data for display on a tablet and/or for display on a smartwatch.

Referring to the figures generally, systems and methods for an IoT cloud computing system are disclosed. More specifically, the systems and methods disclosed herein describe a IoT computing system wherein an IoT cloud is connected over a network to one or more local devices. An IoT cloud computing system may be defined as a network of computing devices (e.g., processors, databases, cellular devices, mobile devices, laptops, tablets, watches, televisions, sensors, gaming devices, smart glasses, wearable devices, fit-ness devices, etc.), mechanical and digital machines, and objects which each have the ability to transfer data to other computing devices, machines, or objects within the network. The computing devices, machines, and objects included in the IoT cloud computing system may be referred throughout the present disclosure as “system devices”. Typically, the system de-vices within a computing system may include large memory and processing devices and be primarily responsible for storing and processing the data within a typical computing system. But in the IoT cloud computing system described in the present disclosure, the processing devices and memory devices for each of the system devices are located on an IoT cloud in order to save space on the system devices. The memory and processing capabilities of the system devices are located on the IoT cloud within a cloud computing system. In some implementations, the device software for each of the system devices may interact in the cloud. In some implementations, the device software (e.g., operating system software, management software, etc.) stored on the cloud may automatically update to the most current version of the device software.

The systems and methods described herein improve the management of one or more system devices within the IoT cloud computing system through software stored on the IoT cloud for that specific system device. For example, the IoT cloud may have a bigger capacity to store and process data (e.g., high capacity servers and databases stored in one location that the IoT cloud may access) and therefore may develop and apply artificial intelligence and machine learning software to one or more system devices which may not have had the capacity for Al/machine learning software on the system device. In some implementations, the device software may be preinstalled software installed in the IoT cloud which the system devices can access either automatically during the operation of the system device or by the control of a management device.

The IoT cloud computing system may be implemented in a variety of applications as will be described in further detail below. For example, one application may be a home automation application (e.g., a smart home system) wherein system devices associated with the home (e.g., lighting devices, HVAC devices, media and entertainment devices, security devices, camera devices, etc.) may be connected to and managed by an IoT cloud computing system through a network associated with the smart home system. As another example, one application may be agricultural monitoring application (e.g., a smart agricultural system) wherein agricultural devices (e.g., sensors, cameras, etc.) may be connected to and managed by an IoT cloud computing system through a network associated with the smart agricultural system. As a final example, one application may a traffic management application (e.g., a smart traffic system) wherein one or more traffic devices (e.g., vehicles, traffic signs, etc.) may be connected to and managed by an IoT cloud computing system through a network associated with the smart traffic system. The examples (e.g., smart home system, smart agricultural system, and smart traffic system) described herein are only meant to exemplary and not limiting. The IoT cloud computing system may be implemented in examples not thoroughly described in the present application including: medical and health care systems, industrial systems, food systems, shipping and delivery systems, etc. In some implementations, the processing performance can be modified in the IoT cloud for a specific application, where different applications trigger different processing power. This can be done simultaneously across many system devices that work with the IoT cloud, so that cloud processing power is conserved and optimized

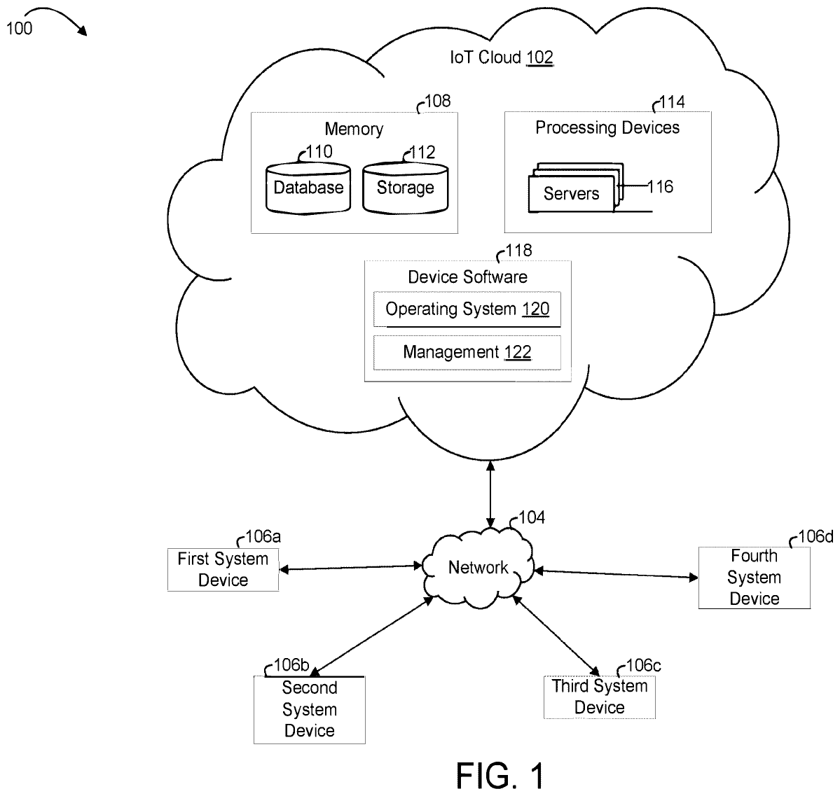

Referring now to FIG. 1, an IoT cloud computing system 100 is shown, according to some implementations. The IoT cloud computing system 100 may be configured to facilitate cloud computing within the cloud computing system 100. In some implementations, the IoT cloud computing system 100 includes an IoT Cloud 102, a network 104, and one or more system devices 106a-106d.

In some implementations, the IoT cloud computing system 100 may include one or more system devices 106a-106d configured to facilitate the use of one or more device soft-ware applications which may be stored on the IoT cloud 102. For example, the system devices 106a-106d may include agricultural applications, home automation applications, healthcare services applications, and traffic applications which may be accessed by a user through the system devices 106a-106d though the applications may be stored on the IoT cloud 202. In some implementations, the applications may be presented to a user through a user interface on the system devices 106a-106d. In some implementations, the system devices 106a-106d may have a pairing function that may be utilized to connect to computers (e.g., mobile phones, watches, laptops, etc.) wherein the computers may manage the system devices through the pairing function.

In some implementations, the IoT Cloud 102 may be configured to receive, process, and store data from the system devices 106a-106d and manage the devices based on the processing power of the IoT Cloud 102. The IoT cloud 102 may include a memory 108 configured to store data received from the one or more system devices 106a-106d. In some implementations, the memory may include a database 110 and/or storage 112. In some implementations, database 110 may store data received by the IoT Cloud 102 in a structured fashion. For example, within the database data may be stored in a way in which the relationship between the data is made clear. Storage 112, on the other hand, may be configured to store large amounts of data on one or more storage devices (e.g., floppy disk, flash drive, etc.) in a largely unstructured fashion (e.g., relationships between the data is not clear). Memory 106 may store machine readable instructions, that when executed by processing devices 114, cause the processing devices 114 to perform one or more management operations to control the one or more system devices 106a-106b. In some implementations, the instructions may be stored in database 110 and/or storage 112. Memory 108 may include, but is not limited to, electronic, optical, magnetic, or any other storage devices capable of providing one or more processing devices 114 with program instructions. Memory 108 may include a floppy disk, CD-ROM, DVD, magnetic disk, memory chip, ROM, RAM, EEPROM, EPROM, flash memory, optical media, or any other suitable memory from which processor 114 can read instructions. The instructions may include code from any suitable computer programming language such as, but not limited to, C, C++, C#, Java, JavaScript, Perl, HTML, XML, Python and Visual Basic

In some implementations, the IoT cloud 102 includes processing devices 114. The processing devices may be configured to execute one or more instructions that may be used to manage the one or more system devices 106a-106b. In some implementations, the processing devices 114 may include server(s) 116. In the cloud computing system context, a server is a virtualized physical infrastructure that provides processing power to a computing system. In some implementations, the server(s) may be an establishment backend server such as an inventory management system or point of sale system, a security system, a web-server, or any other third party functional computational architecture. In some implementations, the processing devices 114 may include a microprocessor, ASIC, FPGA, etc., or combinations thereof. In many implementations, processing devices 114 may be multi-core processors or an array of processors.

In some implementations, the IoT cloud 102 includes device software 118. The device software 118 may be configured to run one or more device software applications on the system devices 106a-106d. A few non-limiting example device software applications include, home automations, agricultural monitors, traffic controllers, web browsers, games, e-mail programs, word processors, utilities, social media portals, calendars, inventory trackers, and point-of-sale (POI) systems. In some implementations, the software programs may be run on one or more system devices 106a-106d. Each application may include computer resources that facilitate operation of the application. For example, the resources may include script elements, image assets, program code, libraries, dependencies, media, and/or other data items. Typically, each resource may consume memory on the system devices 106a-106d. But in the cloud computing system disclosed herein, these application resources are stored on the IoT cloud 102 in order to save memory space on the system devices 106a-106d.

The device software may include operating system software 120 configured to interact with the hardware and software components of the system devices 106a-106d to man-age the memory and processing capabilities of the system device. In some implementations, the operating systems may facilitate communication between a user and system device through a graphical user interface created by the operating system 120. The device software 118 may also include management software 122 configured to manage or control the system devices 106a-106b. In some implementations, device software 118 may include different operating systems 120 and management software 122 for each of the system devices 106a-106b. For example, one of the system devices 106a-106b may be a mobile device and an-other one may be laptop. In this case, the device software 118 may include one operating system for the mobile device and another operating system for the laptop.

The IoT cloud 102 may be communicably coupled to the system devices 106a-106d through network 104. The network 104 may be any type of communication protocol or net-work that facilitates the exchange of information between and among the system devices 106a-106d and the IoT cloud 102. In one embodiment, the network 104 may be configured as a wireless network. In this regard, system devices 106a-106d may wirelessly transmit and receive data from the IoT cloud 102. The wireless network may be any type of wireless network, such as Wi-Fi, WiMAX, Geographical Information System (GIS), Internet, Radio, Bluetooth, ZigBee, satellite, radio, Cellular, Global System for Mobile Communications (GSM), General Packet Radio Service (GPRS), Long Term Evolution (LTE), light signaling, etc. In some implementations, the IoT cloud 102 may be communicably coupled to and receive and transmit data from the system devices 106a-106d through a plurality of networks similar to network 104. In some implementations, the system devices may alternate connection through a network between a cellular network and a Wi-Fi network.

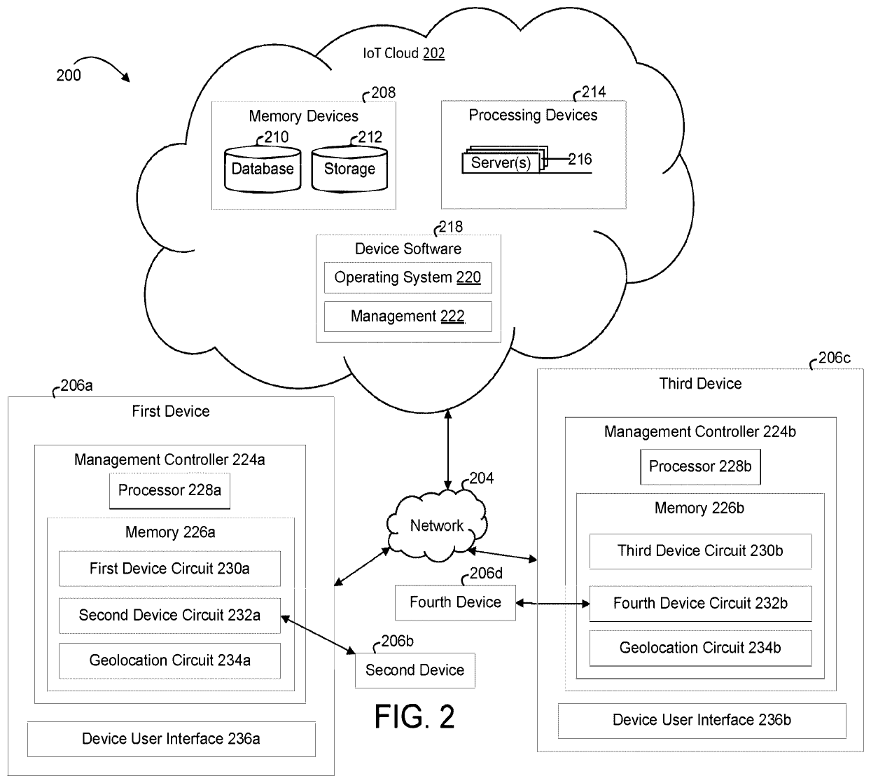

Referring now to FIG. 2, an IoT cloud computing system 200 is shown, according to some implementations. The IoT cloud computing system 200 may be configured to facilitate location based cloud computing. More specifically, the IoT cloud computing system may facilitate the management of one or more system devices 206a-206d by selecting a management device based on location to control the other system devices that share the management device's location. When a system device (e.g., mobile phone, watch, laptop, etc.) is at a similar location as other system devices, the system device may register its location with the IoT cloud. The IoT cloud may then facilitate interactions between all the system devices at the same location. In some implementations, the IoT cloud computing system 200 includes an IoT cloud 202. The IoT cloud computing system 202 may be similar and include many of the same components as the IoT cloud 102 described in the preceding para-graphs. More specifically, the IoT cloud 202 may include memory 208 configured to store machine instructions, that when executed by processing devices 214 cause them to perform one or more of the actions. In some implementations, memory 208 may be similar to and include the same components as memory 108 as described. The memory 208 may include database 210 and storage 212, similar to database 110 and storage 112 described above.

The IoT cloud 202 may include processing devices 214 configured to perform one or more management operations to control the one or more system devices 106a-106d. The processing devices 214 may be similar to and include many of the same components as the processing devices 114 described above. For example, processing devices may include server(s) 216 similar to server(s) 116 described in more detail above.

In some implementations, the IoT cloud computing system 200 may include one or more system devices 206a-206d configured to facilitate the use of one or more device soft-ware applications which may be stored on the IoT cloud 202. For example, the system devices 206a-206d may include agricultural applications, home automation applications, healthcare services applications, and traffic applications which may be accessed by a user through the system devices 206a-206d though the applications may be stored on the IoT cloud 202. In some implementations, the device software applications may be presented to a user through a user interface (e.g., device user interface 236a, device user interface 236b, etc.). In some implementations, the system devices 206a-206d may have a pairing function that may be utilized to connect to computers (e.g., mobile phones, watches, laptops, etc.) wherein the computers may manage the system devices through the pairing function.

In some implementations, the IoT cloud 202 may be communicably coupled to the one or more system devices 206a-206d through network 204 which is configured to transfer data and information between the system devices 206a-206d and the IoT cloud computing system 202. In some implementations, the network 204 may be similar to and include many of the same components as network 104 which is described in more detail above.

In some implementations, the system devices 206a-206d may be grouped based on the location of the system devices 206a-206d. More specifically, each of the system devices 206a-206d may be configured to determine its geolocation and communicate that geolocation to the IoT cloud 202. The IoT cloud 202 may then transmit the system device's geolocation to the other system devices within the IoT Cloud computing system 202. In some implementations, the geolocation of each of the system devices may be determined based on a geolocation sensor (e.g., GPS sensor) placed within each device. Once the geolocation for each system device has been determined, all the devices that share a similar geolocation may be grouped together so that they may be managed together by one “management device”. Grouping and managing devices that share a similar location together may be beneficial for a variety of applications. For example, if a home automation application was implemented using the cloud computing system 200, then each of the home system devices (e.g., security cameras, sensors, media and entertainment devices, home network devices, home appliances, HVAC systems, etc.) may be grouped because they are all located in one location (e.g., the home) and managed together by one management device.

As described above, FIG. 2 shows the IoT cloud computing system 200 configured to group system devices 206a-206d together based on their respective location. For example, first device 206a and second device 206b may each be located at a first location (e.g., Location One). Further, third device 206c and fourth device 206d may each be located at a second location (e.g., Location Two). In this case, the first system device 206a may be assigned as the management device to manage all the devices at Location One (e.g., the first device 206a, second device 206b, etc.). Additionally, the third device 206c may be assigned as the management device to manage all the devices at Location Two (e.g., third device 206c, fourth device 206d, etc.). In some implementations, the management devices (e.g., first device 206a and third device 206c) may function as a relay device to transmit all data and information to and from the non-management devices (e.g., second device 206b and fourth device 206d) to the IoT cloud 202. In some implementations, a specialized device may function as a relay device for a particular location. For example, a Wi-Fi router for a home may be used as a relay device for all the data being transmitted to the IoT cloud 202 from the home. Further, a system device may connect to various relay devices based on the location of the relay device. In some implementations, the system device assigned to be the management device may be a mobile phone device.

In some implementations, the system devices 206a-206d may alternate being as-signed as the “management device” for each of system devices within a location. For example, in the example shown in FIG. 2, the second device 206b may be assigned as the management device instead of the first device 206a. The management devices may alternate in and out of the “management device” position based on the current usage of each of the system devices 206a-206d. For example, if the first device 206a is currently being used to run an application and does not have the capacity to also manage the other devices at the first device's location, then the second device 206b may step in as the management device for the first location.

In some implementations, the management devices (e.g., first device 206a and third device 206c) may include a management controller 224 (e.g., management controller 224a and management controller 224b) configured to manage the devices at the same location as the management devices. The management controller 224 may include a memory 226 (e.g., memory 226a and memory 226b) and processor 228 (e.g., processor 228a and processor 228b). Memory 226 may store machine instructions, that when executed by processor 228 cause processor 228 to perform one or more management operations. Processor 228 may include a microprocessor, ASIC, FPGA, etc., or combinations thereof. In many implementations, processor 228 may be a multi-core processor or an array of processors. Memory 226 may include, but is not limited to, electronic, optical, magnetic, or any other storage devices capable of providing processor 228 with program instructions. Memory 226 may include a floppy disk, CD-ROM, DVD, magnetic disk, memory chip, ROM, RAM, EEPROM, EPROM, flash memory, optical media, or any other suitable memory from which processor 228 can read instructions. The instructions may include code from any suitable computer programming language such as, but not limited to, C, C++, C#, Java, JavaScript, Perl, HTML, XML, Python and Visual Basic.

In some implementations, the memory 228 may include a first device circuit 230a configured to manage the operations of the first device 206a. More specifically, the first device circuit 230 may mange one or more applications that may be run on the first device 206a. For example, the application may include application resources (e.g., application software, scripts, database, etc.) that may be stored on the IoT cloud 202 which may be streamed to the first device 206a and stored in the first device circuit 230a. In some implementations, the memory 228 may include a second device circuit 232a configured to manage the operations of the second device 206b. More specifically, the second device circuit 230 may mange one or more applications that may be run on the second device 206b. For example, the application may include application resources (e.g., application software, scripts, database, etc.) that may be stored on the IoT cloud 202 which may be streamed to the second device 206b and stored in the second device circuit 232a. In some implementations, the second device circuit 232a may be communicably coupled to the second device 206b. For example, the first device 206a and the second device 206b may both be on the same network (e.g., Wi-Fi net-work, Bluetooth network, cellular network, radio network, or any other wireless networks) which may facilitate communication between the second device circuit 232a and the second device 206b. As mentioned above, in some implementations, the second device 206b may transfer information and data to the second device circuit 232a where it may be temporarily stored on the first device 206a. The first device 206a may then relay this information and data to the IoT cloud 202 as described above.

In some implementations, the memory 226a may include geolocation circuit 234a. Geolocation circuit 234a may facilitate sending and receiving location data with IT cloud 202. For example geolocation circuit 234a may send GPS coordinates associated with first device 206a to cloud IoT 202. In some implementations, specific device software 218 may be available to system devices 206a-206d based on a physical location of the system devices 206a-206d. In various implementations, geolocation circuit 234a receives location data from one or more sensors associated the first device 206a. For example, geolocation circuit 234a may receive near field communication (NFC) data from NFC sensors on the first device 206a to determine a position of the first device 206a relative to other system devices within the IoT cloud computing system 200.

In some implementations, the first device circuit 230a, the second device circuit 232a, and the geolocation circuit 234a are embodied as machine or computer-readable media that stores instructions and that is executable by a processor, such as processor 228a. As described herein and amongst other uses, the machine-readable media facilitates performance of certain operations to enable reception and transmission of data. For example, the machine-readable media may provide an instruction (e.g., command, etc.) to, e.g., acquire data from the system devices (e.g., system devices 206a-206d) and transmit that data to the cloud IoT 202. In this regard, the machine-readable media may include programmable logic that defines the frequency of acquisition of the data (or, transmission of the data). The computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the first device circuit 230a, the second device circuit 232a, and the geolocation circuit 234a are embodied as hardware units such as electronic control units. As such, the first device circuit 230a, the second device circuit 232a, and the geolocation circuit 234a may be embodied as one or more circuitry components including, but not limited to, processing circuitry, network interfaces, peripheral devices, input devices, output devices, sensors, etc. In some implementations, the first device circuit 230a, the second device circuit 232a, and the geolocation circuit 234a may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the first device circuit 230a, the second device circuit 232a, and the geolocation circuit 234a may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The first device circuit 230a, the second device circuit 232a, and the geolocation circuit 234a may also include programmable hardware devices such as field programmable gate arrays, programmable array logic, programmable logic devices or the like. The first device circuit 230a, the second device circuit 232a, and the geolocation circuit 234a may include one or more memory devices for storing instructions that executable by the processor(s) of the first device circuit 230a, the second device circuit 232a, and the geolocation circuit 234a. The one or more memory devices and processor(s) may have the same or similar definition as provided above with respect to the memory 226a and processor 228a.

As briefly mentioned above, the first device 206a may also include device user interface 236a. Device user interface 236a may be any electronic device that conveys data to a user by generating sensory information (e.g., a visualization on a display, one or more sounds, tactile feedback, etc.) and/or converts received sensory information from a user into electronic signals (e.g., a keyboard, a mouse, a pointing device, a touch screen display, a microphone, etc.). Device user interface 236a may be internal to the housing of the first device 206a, such as a built-in display, touch screen, microphone, etc., or external to the housing of first device 206a, such as a monitor connected to first device 206a, a speaker connected to first device 206a, etc., according to various implementations.

In the example shown in FIG. 2, the third device 206c may be a management device similar to the first device 206a and may therefore be similar to and include the same components as described with relation to first device 206a. More namely, the third device may include a management controller 224b and a device user interface 236b similar to manage-ment controller 224a and device user interface 236b described above. Further, the management controller 224b may include a memory 226b and processor 228b similar to memory 226a and processor 228b described above. Further, the memory 226b may include a third device circuit 230b, fourth device circuit 232b, and geolocation circuit 234b similar to first device circuit 230a, second device circuit 232a, and geolocation circuit 234b respectively.

As described above, all the system devices 206a-206d may alternate in and out of the “management device” position. Therefore, the second device 206b and the fourth device 206d may have the same components and architecture as the first device 206a and the third device 206c though these components are not shown in FIG. 2 for the sake of simplicity.

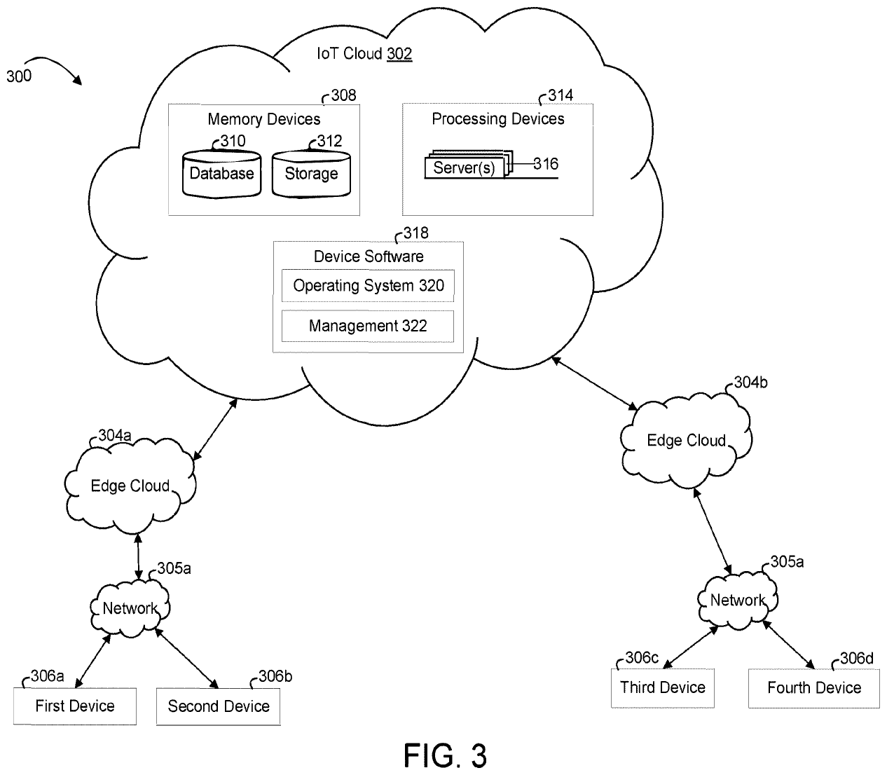

Referring now to FIG. 3, an IoT cloud computing system 300 is shown, according to some implementations. The IoT cloud computing system 200 may be configured to real-locate a portion of the computing functions carried out by the IoT cloud 302 to one or more edge clouds, such as edge clouds 304a-304b for faster computing within the system devices 306a-306d. In the cloud computing systems shown in FIG. 1 and FIG. 2, the majority of the computing functions are carried out in IoT cloud 102 and IoT cloud 202 respectively. While the IoT cloud may have nearly limitless memory and processing capabilities, the IoT cloud may be located far enough that the transfer of data between the IoT cloud and the system devices may take longer than may be desired. The benefit of the IoT cloud computing system 300 is that some of the memory and processing capabilities of the IoT cloud 302 may be reallocated to the edge clouds 304a-304b which are closer to the system devices 306a-306d so that the memory storage and processing of device software such as device software 318 may be done more quickly because the data does not have to transfer as far. For example, a company may store and run one or more agricultural monitoring applications through a cloud computing system such as IoT cloud computing system 300. The agricultural cloud computing system may include one main IoT cloud located at a central location and one or more edge clouds dispersed closer to the locations (e.g., farms, etc.) where the agricultural applications may be used.

In some implementations, the IoT cloud computing system 300 includes an IoT cloud 302. The IoT cloud computing system 302 may be similar and include many of the same components as the IoT cloud 102 described in the preceding paragraphs. More specifically, the IoT cloud 302 may include memory 308 configured to store machine instructions, that when executed by processing devices 314 cause them to perform one or more of the actions. In some implementations, memory 308 may be similar to and include the same com-ponents as memory 108 as described. The memory 308 may include database 310 and storage 312, similar to database 110 and storage 112 described above.

The IoT cloud 302 may include processing devices 314 configured to perform one or more management operations to control the one or more system devices 106a-106d. The processing devices 314 may be similar to and include many of the same components as the processing devices 114 described above. For example, processing devices may include server(s) 316 similar to server(s) 116 described in more detail above.

In some implementations, the IoT cloud computing system 300 may include one or more system devices 306a-306d configured to facilitate the use of one or more applications which may be stored on the IoT cloud 302. For example, the system devices 306a-306d may include agricultural applications, home automation applications, healthcare services applications, and traffic applications which may be accessed by a user through the system devices 306a-306d though the applications may be stored on the IoT cloud 302. In some implementations, the applications may be presented to a user through a user interface on the system devices 306a-306d. In some implementations, the system devices 306a-306d may have a pairing function that may be utilized to connect to computers (e.g., mobile phones, watches, laptops, etc.) wherein the computers may manage the system devices through the pairing function.

In some implementations, the IoT cloud 202 may be communicably coupled to the one or more edge clouds 304a-304b which may be communicably coupled to system devices 306a-306d through networks 305a-305b which is configured to transfer data and information between the system devices 306a-306d and the IoT cloud computing system 302. In some implementations, the networks 305a-305b may be similar to and include many of the same components as network 104 which is described in more detail above.

In some implementations, system devices 306a-306d that are related to each other may be associated with and communicably coupled to the same edge cloud. Going back to the agricultural cloud computing system example, first device 306a and second device 306b may be agricultural devices (e.g., sensors, laptops, mobile devices, etc.) associated with a first farming location and therefore may be communicably coupled to edge cloud 304a which may be located near a particular farming location for faster processing of the agricultural applications used at the first farming application. As another example, third device 306c and fourth device 306d may be medical devices associated with a particular hospital. The medical de-vices may be communicably coupled to an edge cloud 304b which may be located near a hospital for faster processing of medical applications that may be run on third device 306c and fourth device 306d.

In some implementations, the edge clouds 304a-304b may be similar to the IoT cloud 302. For example, similar to the IoT cloud 302, the edge clouds 304a-304b include processing devices, memory devices, and device software that are configured to facilitate the running of one or more applications on the system devices 306a-306d. In some implementations, the edge clouds 304a-304b may only include a portion of the processing and memory storage capabilities of the IoT cloud 302. For example, going back to the agricultural computing system example, the edge cloud associated with the particular farming location may only include the memory storage and processing capabilities necessary to run agricultural applications.

In some implementations, the edge clouds 304a-304b may be a third party server. For example, the third party server may be configured to store and process third party software and provide access to the third party specific software to system devices 306a-306d by drawing data from one or more other third party servers and/or IoT clouds 302. In some implementations, the IoT cloud 302 may automatically send third party software during operation of the system devices where the third party server may process the data. The data may then be automatically processed and transferred back to the IoT cloud 302 which may then be transferred to the system devices 306a-306d. In some implementations, the third party server and/or software may be located outside the IoT cloud 302. To continue the example, the third party software data may be stored on the edge cloud computing third party server and retrieve establishment specific data (e.g., agricultural data, medical services data, etc.) from one or more third party servers such as edge clouds 304a-304b. In some implementations, the third party server be located with substantial proximity to a respective establishment compared to the IoT cloud 302 which may be located at a central location to better serve multiple establishments. For example, a third party server associated with hospital which communicates with medical devices may be located on the premises of the hospital for easy connection to the medical devices. To continue the example, the third party server may stream the applications to the system devices 306a-306d. In some implementations, the third party server may stream an application to one or more system devices 306a-306d based on the location of the system devices. For example, the third party server may terminate streaming an application to a system device which may be a predetermined distance away from the third party server. In some implementations, a third party server may store one or more applications or device software 318 for system devices 306a-306d. Additionally or alternatively, third party server may store dependencies of applications or device software which may have been stored in device software 318. These dependencies may include script libraries, assets, parameters, data, etc. In some implementations, third party servers and/or system devices 306a-306d may store information locally which may be accessed by other system devices within IoT cloud computing system 302. In some implementations, a user may have a cloud account in which the user may giver permissions on which data stored locally on a system device (e.g., images, videos, text messages, etc.) may be shared with other devices within the same cloud computing system. For example, a user may give permission that the information stored locally on system devices 306a-306d that may be accessed at any location by any of the users other devices on the cloud.

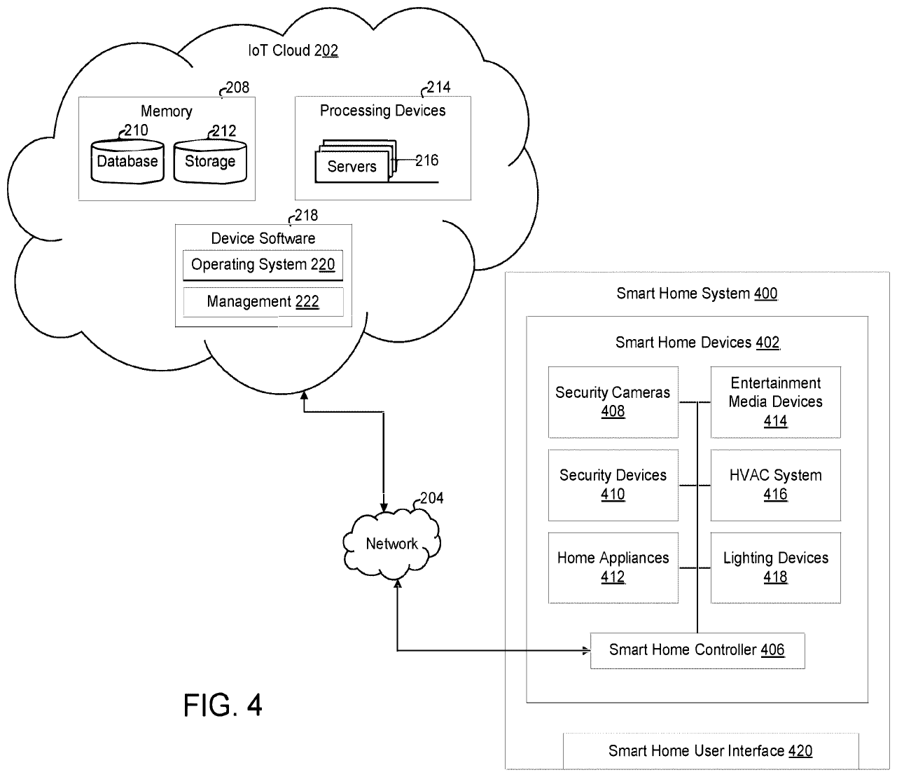

Referring now to FIG. 4, a smart home system 400 connected to cloud computing system 200 is shown according to some implementations. More specifically, FIG. 4 demonstrates an example use case of the location based cloud computing architecture described in FIG. 2. The IoT cloud 202 may include one or more applications or device software configured to run the smart home system 400 stored within device software 218. For example, the IoT cloud 202 may include home security applications, home entertainment applications, home HVAC system applications, etc. The IoT cloud 202 may store and process these applications using the memory devices 208 and the processing devices 214 as described above. These applications may then be streamed to one or more devices associated with the smart home system. The smart home system 400 may be a home automation system configured to automatically control one or more devices and systems in the home. For example, the smart home system 400 may turn on and tum off the security cameras and other security devices within the home based on a signal received that the occupant of the home has entered. As another example, the smart home system may automatically control the lighting in the home based on the preferences of the occupant of the home (e.g., lights automatically off after 10 minutes without movement, lights off based on timers set by the user, light dimming over the course of a period of time, etc.).

As described above with relation to FIG. 2, an IoT cloud computing system may configured to group system devices together based on their respective location. Additionally, the IoT cloud (e.g., in this case IoT cloud 202) may facilitate the management of one or more system devices by selecting a management device based on location to control the other system devices that share the management device's location. In this case, the system devices may be smart home devices 402 which may be grouped together based on the location of the home which they are a part of. In this case, the management device may be smart home controller 406. Smart controller 406 may be responsible for receiving all the data associated the other smart home devices (e.g., security cameras 408, security devices 410, home appliances 412, entertainment media devices 414, HVAC system 416, and lighting system 418 and relaying this data to the IoT cloud 202 where the data may be stored and processed to run the home automation applications on the system devices.

In some implementations, the smart home devices 402 may include security cam-eras 406. Security cameras 406 may be positioned at various locations inside and outside the home and may be configured to trigger an alert and/or provide documentation of any nefarious activities happening within the home. In some implementations, the operations of the security cameras 406 may be controlled by the smart home controller 406. In some implementations, the smart home devices may include security devices 410. Security devices 410 may include but are not limited to locks, sensors (e.g., motion sensors, heat sensors, light sensors, etc.), and alarms. Security devices 410 may be configured to detect and document security breaches with the home and/or alert the proper authorities of such security breaches. In some implementations, the operations of security devices 410 may be managed by the smart home controller 406.

In some implementations, the smart home devices 402 may include home appliances 412. Home appliances 412 may include but are not limited to kitchen appliances (e.g., oven, microwave, dishwasher, etc.), washing machines, dryers, etc. Home appliances 412 may be configured to perform various operations across the home which may be automated through smart home system 400. For example, the oven may automatically be turned off if

no movement is observed in the home for a predetermined amount of time as a safety precaution. In some implementations, the operation of home appliances 412 may be managed by the smart home controller 406.

In some implementations, smart home devices 402 may include entertainment media devices 414. Entertainment media devices 414 may include but are not limited to televisions, speakers, sound systems, laptops, mobile devices, etc. Entertainment media devices may be configured to provide entertainment within the home which may be automated through smart home system 400. For example, a speaker may be operated to automatically play song at a predetermined time every day. In some implementations, the operation of entertainment media devices 414 may be managed by the smart home controller 406.

In some implementations, smart home devices may include heating, ventilation, and air-conditioning (HVAC) system 416. HVAC system 416 may be configured to control air flow within the home so as to keep the air at a predetermined temperature. In some implementations, HVAC system 416 may be automated as part of the smart home system 400. For example, HVAC system 416 may be automated to control the temperature of the home so that heating, gas, and electric bills for the house stay under a predetermined amount. As another example, HVAC system 416 may be automated to control the temperature of the home so that amount of natural resources used to run HVAC system 416 stay below a certain threshold. In some implementations, the operation of HVAC system 416 may be managed by the smart home controller 406.

In some implementations, smart home devices may include lighting devices 418 configured to provide lighting to the home. Lighting devices 418 may include but are not limited to LED lightbulbs, smart lightbulbs, and the electrical circuits used to power the LED lightbulbs or smart lightbulbs. In some implementations, lighting devices 418 may be auto-mated by the home automation system 400. For example, the lights may be controlled to automatically turn off without any movement within the home for a certain period of time (e.g., one half of an hour, one hour, two hours, etc.). In some implementations, the operation of lighting 418 may be managed by the smart home controller 406.

Smart home controller 406 may be coupled to each of the smart home devices described above so that it may gather information and data from each of the smart home devices and relay the information and data to the IoT cloud 202 where the data may be stored and processed. Therefore, the smart home controller may be communicably coupled to each of the smart home devices (e.g., security cameras 408, security devices 410, home appliances 412, entertainment and media devices 414, HVAC system 416, and lighting devices 418). Additionally, smart home controller 406 may also be communicably coupled to IoT cloud 202 through network 204.

In some implementations, smart home system 400 may include smart home user interface 420 configured to provide a graphical display to a user of the state and operations of each of the smart home devices within smart home system 400. Smart home user interface 420 may be any electronic device that conveys data to a user by generating sensory information (e.g., a visualization on a display, one or more sounds, tactile feedback, etc.) and/or converts received sensory information from a user into electronic signals (e.g., a keyboard, a mouse, a pointing device, a touch screen display, a microphone, etc.).

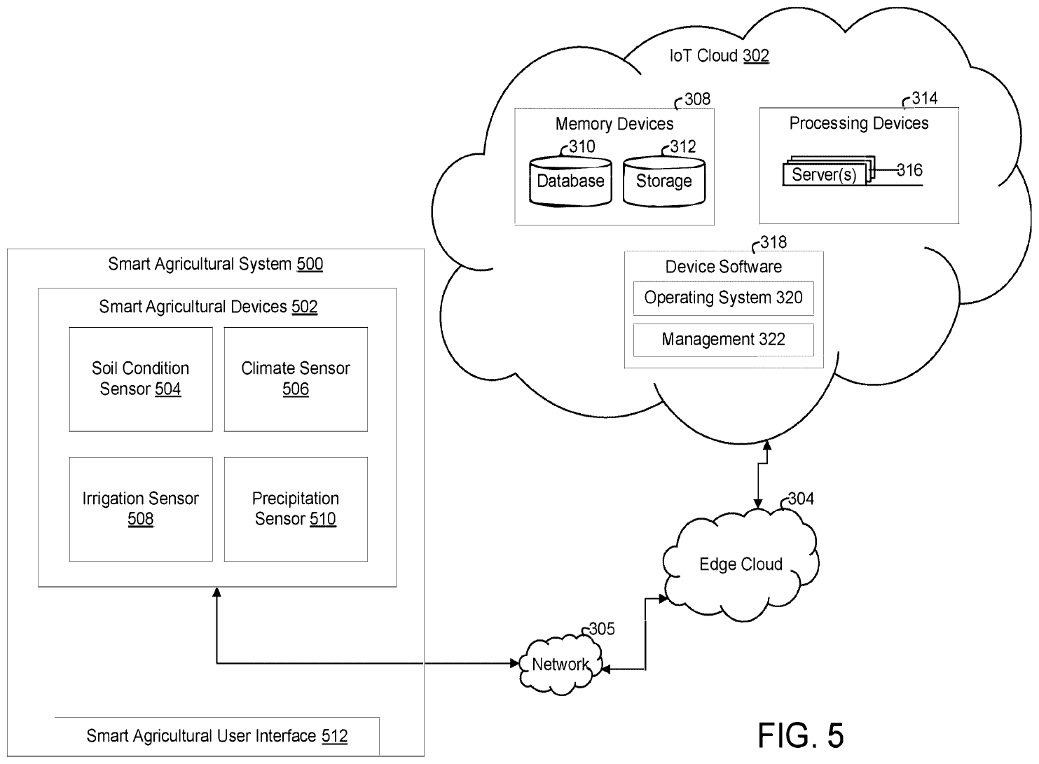

Referring now to FIG. 5, a smart agricultural system 500 connected to cloud computing system 300 is shown according to some implementations. More specifically, FIG. 5 demonstrates an example use case of the edge cloud based cloud computing architecture described in FIG. 3. In the example use case shown in FIG. 5, the smart agriculture system 500 may be communicably coupled to edge cloud 304 through network 305. Additionally, edge cloud 304 may be communicably coupled to IoT cloud 302. The IoT cloud 302 may include one or more agricultural applications that may facilitate running one or more devices within the smart agricultural system 500. As described above in more detail with respect to FIG. 3, the agricultural applications related to smart agricultural system 500 may be reallocated to be stored and processed on edge cloud 304 for faster processing. Faster processing may happen because edge cloud 305 may be located closer to the smart agricultural system 500. For example, the edge cloud may be located near the farming location of where the smart agricultural system 500 may be implemented. Data may be transferred between smart agricultural system 500 and the edge cloud 304 and/or IoT cloud 302 based on through network 305. In some implementations, network 305 and edge cloud 304 are similar and include many of the same components as networks 305a-305b and edge clouds 304a-304b as described in more details above.

In some implementations, smart agricultural system 500 includes smart agricultural devices 502 which may be configured to monitor and provide information about conditions related to an agricultural practice. In some implementations, smart agricultural devices 502 includes a soil condition sensor 504 configured to collect and provide data about the soil to the edge could 304 where it may be used within one or more agricultural applications. For example, the soil condition sensor 504 may measure the nutrient content of the soil, the moisture content of the soil, the density of the soil, etc. Soil condition sensor 504 may then provide this data to the edge cloud 304 through network 305.

In some implementations, smart agricultural devices 502 includes climate sensor 506. Climate sensor 506 may be configured to collect and provide data about climate where climate sensor 506 is placed. Climate sensor 506 may provide data including but not limited to temperature, wind speed, sunshine levels, humidity, wind chill, etc. Climate sensor 506 may then provide this climate data to edge cloud 304 through network 305 to be used within the one or more agricultural applications.

In some implementations, smart agricultural devices includes irrigation sensor 508. Irrigation sensor 508 may be configured to collect and provide data about the irrigation within an agricultural practice. For example, irrigation sensor 508 may be a motion sensor that determines when an irrigation device is activated and how long the irrigation device is activated. As another example, irrigation sensor 508 may be a flow rate sensor that determines the amount of fluid dispelled by the irrigation device. Once this data has been gathered, irrigation sensor 508 may provide the irrigation data to edge cloud 304 through network 305 to be used within the one or more agricultural applications.

In some implementations, smart agricultural devices include precipitation sensor 510 which may be configured to collect and provide data about the precipitation where precipitation sensor 510 is located. For example, precipitation sensor 510 may measure the amount of precipitation received (e.g., rain, hail, snow, sleet, etc.). Precipitation sensor 510 may then provide this precipitation data to edge cloud 304 through network 305 to be used within the one or more agricultural applications. In some implementations, the precipitation sensor 510 may be included in the climate sensor 506.

In some implementations, smart agricultural system 500 may include smart agricultural user interface 512 configured to provide a graphical display to a user of the state and operations of each of the smart agricultural devices within smart agricultural system 500. Smart agricultural user interface 512 may be any electronic device that conveys data to a user by generating sensory information (e.g., a visualization on a display, one or more sounds, tactile feedback, etc.) and/or converts received sensory information from a user into electronic signals (e.g., a keyboard, a mouse, a pointing device, a touch screen display, a microphone, etc.).

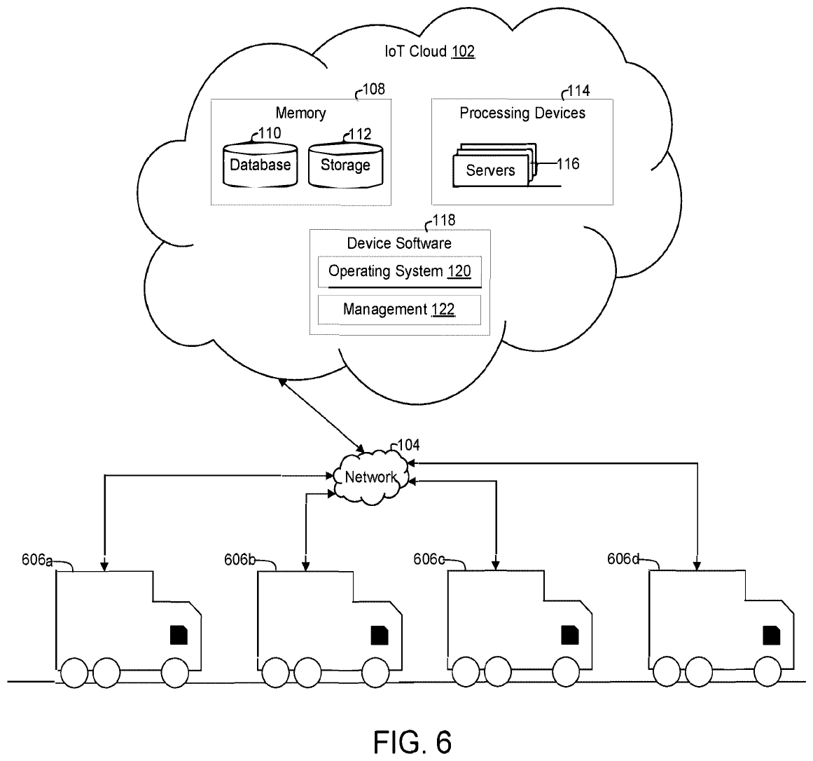

Referring now to FIG. 6, a smart traffic system 600 connected to IoT cloud 102 is shown according to some implementations. More specifically, FIG. 6 demonstrates an example use case of the cloud computing architecture described in FIG. 1 for controlling one or more vehicles which may be travelling together as part of a platoon. Platooning may be described as a method of driving a plurality of vehicles together as part of a group. The plurality of vehicles may be communicably coupled to each other in order to exchange information (e.g., speed, acceleration, deceleration, distance tracking, etc.) for each vehicle that may facilitate control of each of the vehicles. For example, if four vehicles are travelling together and the lead vehicle starts to decelerate, the other vehicles in the platoon may receive information that the lead vehicle is braking so that they may also decelerate accordingly. Control within the vehicles may be automated within the plurality of vehicles to realize a variety of benefits. These benefits include increased fuel economy for each vehicle within the platoon, less space between each of the vehicles leading to less traffic, safer driving because vehicle information is being shared to highlight just a few.

The IoT cloud computing system architecture described in FIG. 1 may be used to implement smart traffic control system 600 for controlling a plurality of vehicles within a platoon. More specifically, vehicles 606a-606d may travelling together as a platoon. Each of the vehicles 606a-606d may be communicably connected to the IoT cloud 102 through network 104. IoT cloud 102 may include one or more traffic applications that may be used to manage the vehicles 606a-606d as they travel as a platoon. The vehicles 606a-606d may provide vehicle traffic information and data (e.g., speed, acceleration and deceleration of each vehicle, distance between each vehicle, etc.) to cloud IoT 102 which may then be used within one or more traffic applications used to control the vehicles 606a-606d.

### Configuration of Exemplary Embodiments

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all ofthe elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the pre-sent disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include data-base components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having ma-chine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the de-scribed methods could be accomplished with standard programming techniques with rule-based logic and other logic to accomplish the various connection steps, processing steps, comparison steps, and decision steps.

It is important to note that the construction and arrangement of the virtualization system 100, third party interface 300, and virtualization application 400 as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A cloud computing system comprising:
one or system devices configured to collect and transmit data;
an internet-of-things (IoT) cloud configured to provide processing and memory storage capabilities to the system devices, the IoT cloud comprising:
one or more device software applications configured to run the one or more system devices;
a processing circuit comprising at least one processor and memory, the memory having instructions stored thereon, that when executed by the at least one processor cause the processing circuit to:
communicably couple the one or more system devices to the IoT cloud through a network;
receive the data from the one or more system devices;
determine a correct software application of the one or more device software applications to stream to a correct device of the one or more system devices based on the data received from the one or more system devices; and
stream the correct software application to the correct device;
wherein the one or more device software applications are not stored locally on the one or more system devices.

2. The cloud computing system of claim 1, wherein the one or more device software applications may utilize at least one of an artificial intelligence model or a machine learning model to apply to the system devices.

3. The cloud computing system of claim 1, wherein the one or more system devices are communicably coupled to a wireless communication device, wherein the wireless communication device sends and receives the data from the one or more system devices to the IoT cloud over a network.

4. The cloud computing system of claim 1, wherein the one or more device software applications includes at least one of an operating system software or a management software for the one or more system devices.

5. The cloud computing system of claim 1, wherein the network is at least one of a cellular network, a Wi-Fi network, or a Bluetooth network.

6. A cloud computing system comprising:
one or system devices configured to collect and transmit data;
an internet-of-things (IoT) cloud configured to provide processing and memory storage capabilities to the system devices, the IoT cloud comprising:
one or more device software applications configured to run the one or more system devices;
a processing circuit comprising at least one processor and memory, the memory having instructions stored thereon, that when executed by the at least one processor cause the processing circuit to:
receive a geolocation for each of the one or more system devices;
compare the geolocation for each of the one or more system devices;
determine a location where one or more system devices have the same location based on the comparison;
designate one of the one or more system devices at the location as a management device for all the system devices associated with the location;
communicably couple the management device to the IoT cloud through a network;
receive the data from the management device;
determine a correct software application of the one or more device software applications to stream to a correct device of the one or more system devices based on the data received from the management device; and
stream the correct software application to the correct device;
wherein the one or more device software applications are not stored locally on the one or more system devices.

7. The cloud computing system of claim 6, wherein the one or more system devices al-ternate being designated as the management device.

8. The cloud computing system of claim 6, wherein each system device associated with the location is communicably connected to the management device.

9. The cloud computing system of claim 6, wherein one or more system devices are categorized as having the same location if the one or more system devices are within a pre-determined distance to each other.

10. The cloud computing system of claim 6, wherein the one or more device software applications may utilize at least one of an artificial intelligence model or a machine learning model to apply to the system devices.

11. The cloud computing system of claim 6, wherein the one or more device software applications includes at least one of an operating system software or a management software for the one or more system devices.

12. The cloud computing system of claim 6, wherein the network is at least one of a cellular network, a Wi-Fi network, or a Bluetooth network.

13. The cloud computing system of claim 6, wherein the system devices include at least one of a mobile phone device, a laptop, a tablet, a watch, or a television.

14. A cloud computing system comprising:
one or system devices configured to collect and transmit data;
an internet-of-things (IoT) cloud configured to provide processing and memory storage capabilities to the system devices, the IoT cloud comprising:
one or more device software applications configured to run the one or more system devices;
a processing circuit comprising at least one processor and memory, the memory having instructions stored thereon, that when executed by the at least one processor cause the processing circuit to:
receive a geolocation for each of the one or more system devices;
compare the geolocation for each of the one or more system devices;
determine a where one or more system devices have the same location based on the comparison;
generate an edge cloud to be located near the location where the one or more system devices have same location based on the comparison; and
communicably couple the one or more system devices to the edge cloud through a network;
wherein the one or more device software applications are not stored locally on the one or more system devices.

15. The cloud computing system of claim 14, wherein the edge cloud comprises:
the one or more device software applications configured to run the one or more system devices;
the processing circuit comprising the at least one processor and memory, the memory having instructions stored thereon, that when executed by the at least one processor cause the processing circuit to:
receive the data from the one or more system devices;
determine a correct software application of the one or more device software applications to stream to a correct device of the one or more system devices based on the data received from the one or more system devices; and
stream, by the edge cloud, the correct software application to the correct device.

16. The cloud computing system of claim 15, wherein the one or more device software applications on the edge cloud may be a subset of the one or more device software applications on the IoT cloud, wherein the one or more device software applications on the edge cloud directly relate to the system devices that have same location.

17. The cloud computing system of claim 15, wherein the edge cloud is located near the location where the one or more system devices have same location to facilitate faster device software application processing.

18. The cloud computing system of claim 14, wherein one or more system devices are categorized as having the same location if the one or more system devices are within a pre-determined distance to each other.

19. The cloud computing system of claim 14, wherein the one or more device software applications may utilize at least one of an artificial intelligence model or a machine learning model to apply to the system devices.

20. The cloud computing system of claim 14, wherein the one or more device software applications includes at least one of an operating system software or a management software for the one or more system devices.
